(19) United States
(12) Patent Application Publication
(10) Pub. No.: US 2010/0124588 A1
(43) Pub. Date: May 20, 2010

(54) Pre-Formed One-Piece Filling For A Meatball Sandwich

(75) Inventor: Dinesh Bhatnagar, Calgary (CA)

Correspondence Address: BISHOP & DIEHL, LTD., 1320 TOWER ROAD, SCHAUMBURG, IL, 60173, US

(73) Assignee: New Food Classics, Calgary (CA)

(21) Appl. No.: 12/617,324

(22) Filed: Nov. 12, 2009

Related U.S. Application Data
(60) Provisional application No. 61/114,512, filed on Nov. 14, 2008.

(51) Int. Cl. A23L 1/31; A23L 1/314; A23L 1/317; A23B 4/06

(52) U.S. Cl. 426/92; 426/641; 426/615; 426/646; 426/513; 426/393; 426/302; 426/332

(57) ABSTRACT

Disclosed is a one-piece edible filling for a meatball sandwich, formed from ground meat or other foodstuff which can be readily molded or shaped. The filling includes a generally flat base with an array of projections protruding from the base, such that the projections are connected together through the base. Each projection generally has the configuration of a meatball or portion thereof. The filling can be configured to form a filling for bun, roll or other sandwich casing to form a meatball sandwich when combined with said sandwich casing.

### CROSS-REFERENCE TO RELATED APPLICATIONS

The present application claims the benefit of U.S. Application No. 61/114,512, filed on Nov. 14, 2008, which is incorporated by reference herein in its entirety.

### FIELD OF THE INVENTION

The invention relates to foodstuffs for human consumption, namely a ground meat product intended for use as an insert or filling for a sandwich, as well as a sandwich containing this foodstuff and methods and processes for preparing a sandwich filling and a sandwich of this type.

### BACKGROUND TO THE INVENTION

Sandwiches containing meat fillings are perennially popular amongst consumers. One such foodstuff is the so-called “meatball sandwich.” Conventional forms of this type of sandwich include the submarine sandwich and other roll or bun-based sandwiches. Such sandwiches typically consist of multiple meatballs placed within a roll or other breadstuff, usually with additional constituents such as sauce. The breadstuff may consist of separate halves of a roll, or a roll or other breadstuff having a slice or groove along one side which may be stuffed with a filling or insert, or a breadstuff having a pocket for receiving a filling. Meatball sandwiches can be based on essentially any configuration of breadstuff, such as round, oval or rectangular rolls or breadstuffs. The meatballs may comprise beef, pork, or other types of meat, or non-meat foodstuffs such as soy or other bean-based or vegetarian substrates.

The conventional use of multiple meatballs within this type of sandwich presents difficulties and drawbacks to those who prepare, serve and consume this type of sandwich. For example, the preparer must individually form, cook and place the meatballs within the sandwich. Additional steps can be required if the meatballs are prepared and cooked in advance, and subsequently re-heated by the server. These steps when carried out for a multitude of individual meatballs typically add to the complexity and resulting costs associated with preparing and serving this type of foodstuff. Portion control can be difficult, as this relies upon the individual server supplying the correct number of meatballs for the sandwich. From the consumer's perspective, meatball sandwiches represent a tasty meal, but suffer the drawback of potentially messy eating if a loose meatball dislodges from the sandwich.

It is believed that there is a need to address at least some of the above problems and thereby to provide an improved meatball sandwich and method of preparing the same.

### SUMMARY OF THE INVENTION

The present invention relates to a foodstuff comprising a one-piece filling or insert for a meatball sandwich, intended to be used within a roll or between bread slices or other breadstuff sandwich casing. The invention relates to a product formed from a moldable or formable foodstuff such as ground meat, as well as other formulas containing ground meat, vegetables or any other suitable substrate. The invention comprises a one-piece sandwich filling which emulates a plurality of individual meatballs. The filling is intended to be placed within a roll, bun, other sandwich breadstuff. According to one aspect, the invention relates to a formed ground meat product, comprising a generally flat base with an array of generally spherical projections, or meatball units, protruding from one face of the base. The term “spherical” as used herein is not intended to be limited to perfectly shaped spheres but includes a wide range of configurations, wherein the meatball units may take on essentially any shape which generally resembles a meatball. For example, the meatball units may comprise a partial spherical shape, such as a hemisphere, or an irregular shape that only roughly resembles a sphere. Preferably, the base comprises a relatively thin, flat sheet. The meatball units projecting from the base emulate the appearance of a plurality of individual meatballs. The meatball units are effectively joined together and prevented from independent motion by the base so as to provide a one-piece member which may be inserted in its entirety into a roll or other sandwich casing. The product thus provides a sandwich having the appearance of a conventional meatball sandwich comprising multiple meatballs, but is in fact formed with a one-piece filling member. The base may take on any desired configuration which generally matches the shape and size of the desired sandwich, including rectangular, square, oval, circular, boat-shaped etc. In a similar fashion, the meatball unit array may comprise a linear array consisting of several meatball units in a row, or any selected non-linear array conforming generally to the configuration of the base. The size, configuration and spacing of the meatball units can vary widely, and there is no particular limitation thereon, beyond the practical limits imposed by foodstuffs of this nature.

According to another aspect, the meatball units may project from both faces of the base, for example to provide a staggered array in which the units project in an alternating arrangement on the opposing sides of the base.

The foodstuff may comprise any suitable type of ground meat or ground meat mixture, or non-meat substrate. For example, it may be formed from conventional ground beef or a ground beef mixture containing non-meat ingredients such as flavourings, binders, water, and other suitable ingredients. The substrate may comprise a meat-based substrate as described in Canadian Patent No. 2444785 which emulates the taste and texture of prime rib meat. Alternatively, other formable or moldable foodstuffs may be formed into the structure, including non-beef meats or vegetarian mixtures suitable for forming into a molded configuration of the type described herein.

According to another aspect, the foodstuff comprises a pre-formed and pre-cooked one-piece filling for a meatball sandwich, suitable for delivery to a restaurant or other consumer in a form ready to heat and serve within a sandwich. According to this aspect, the foodstuff is pre-cooked, optionally frozen and packaged for delivery to the consumer. At the consumer or server's end, the article is heated and assembled into a suitable sandwich. According to one aspect, the foodstuff may be coated with a suitable sauce prior to freezing, such that additional sauce is not required to be added prior to serving.

According to another aspect, the invention may comprise a sandwich comprising a roll or breadstuff in combination with a one-piece filling as described above. The sandwich may be prepared in advance of serving and frozen or refrigerated for re-heating prior to serving, or alternatively assembled immediately prior to serving from a heated and fully cooked filling being placed within the roll or breadstuff.

According to a still further aspect, the invention relates to a process for preparing a foodstuff as described above, consisting of forming one or more meatball sandwich fillings as described above within a mold or press such that the filling comprises a one-piece foodstuff; arranging a plurality of such uncooked fillings on a baking surface; cooking the articles within an oven at a suitable temperature or temperatures for a predetermined duration, followed by removal from the oven for cooling. Optionally, the filling may be coated with a layer of a suitable sauce or other edible substance. The articles are then optionally frozen and individually packaged for delivery to a consumer. Preferably, the packaging includes instructions for preparation of the foodstuff by the consumer or server. For example, such instructions may require opening of the packaging followed by re-heating within selected parameters of temperature and duration. The filling may be re-heated within the packaging, for example by microwaving or baking, or alternatively removed from the packaging prior to heating. The filling may be heated from a frozen state, or initially thawed, although it is preferable that the filling be re-heated from frozen in order to prevent breakage of the base prior to serving. The heated filling is then placed on or within a roll or other breadstuff having a suitable configuration substantially conforming and matching the configuration of the base. Optionally, a sauce may be poured over the filling, especially if the filling is not pre-sauced, and the completed sandwich served to a diner.

The present invention will now be further described and illustrated by means of a description of detailed embodiments thereof. It will be understood that the present invention is not limited in its scope to the embodiments described in detail herein, these being merely illustrative of the present invention. A skilled person will understand that the present invention as defined in the specification as a whole, including the claims hereof, includes departures from and variations of the detailed embodiments described herein.

As used herein, the terms “insert” and “filling” are used interchangeably, and refer to an article which may be inserted within a roll or other sandwich casing (normally a breadstuff), so as to form a sandwich. Although additional components and constituents may be added to such sandwich, it is contemplated that the insert consists of essentially the entirety or at least the substantial part of the sandwich filling.

The term “meatball” as used herein is not intended to be limited to a foodstuff which comprises essentially meat. Rather, it may contain only a portion of meat, or a vegetarian meatball comprising no meat at all. The term “meatball” is thus used in a very general sense to describe a foodstuff which resembles a conventional meatball.

The term “sandwich casing” is used herein to refer generically to any type of foodstuff which may form the exterior of a sandwich. Normally, this consists of opposed halves of a roll, bun, or slices of bread, or other breadstuff. It may also consist of a pocket bread, or a non-bread foodstuff which serves the function of a sandwich exterior. Likewise, the term “sandwich” is used broadly herein and refers generally to any foodstuff which includes a sandwich casing and a filling. It will be understood that there exist a wide variety of foodstuffs which may be defined or considered to be a sandwich; this invention is intended to encompass all such varieties that reasonably lend themselves to a meatball filling. By way of non-limiting examples, a sandwich may comprise an “open face” sandwich having a single, unopposed slice of bread or roll, or a sandwich having two, three or more bread or roll slices in a stacked array. A sandwich may comprise pocket-type or rolled-up flatbread configurations.

It will be further understood that directional references used herein are provided merely for ease of description, and do not limit the scope of the invention. For example, references such as “up”, “down”, and the like refer to a meatball sandwich or sandwich insert oriented in a normal horizontal position, as would be found on a plate. Likewise, a term such as “base” or “topping” is not intended to refer to any particular directional or locational aspect. Any dimensions, particular ingredients and the like are presented merely as illustrations and do not limit the scope of the invention. References to specific ranges of sizes or quantities, whether or not qualified with the term “about” or similar terminology, are understood to be capable of varying by up to 10 percent. It will be further understood that in the context of this invention, geometrical terms such as “spherical” are not intended to describe mathematically precise shapes, but are only rough approximations of such shapes as is expected in the context of shaped foodstuffs that undergo deformation and the like.

### BRIEF DESCRIPTION OF THE DRAWINGS

FIG. 1 is a perspective view of a first embodiment of the present invention;

FIG. 2 is a side elevational view of the embodiment of FIG. 1;

FIG. 3 is a plan view, from above, of the embodiment of FIG. 1;

FIG. 4 is a perspective view of the embodiment of FIG. 1, with a layer of sauce thereon;

FIG. 5 is a side elevational view of a sandwich which contains a filling according to the present invention;

FIG. 6 is a perspective view of a second embodiment of the present invention;

FIG. 7 is a perspective view of a third embodiment of the invention;

FIG. 8 is a perspective view of a fourth embodiment of the invention;

FIG. 9 is a perspective view of a fifth embodiment of the invention;

FIG. 10 is a perspective view of a sixth embodiment of the invention;

FIG. 11 is a perspective view of a seventh embodiment of the invention; and

FIGS. 12 through 16 are photographs of embodiments of the present invention.

### DETAILED DESCRIPTION

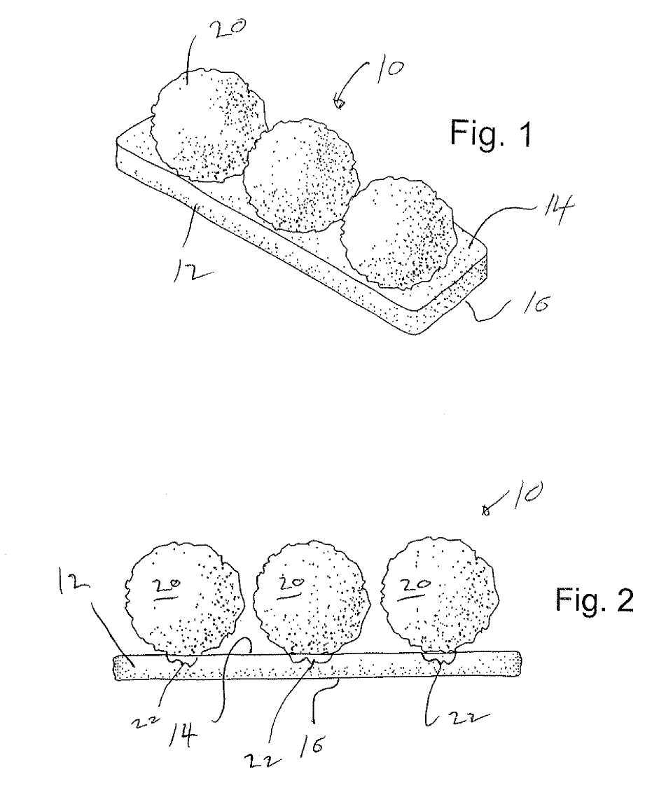

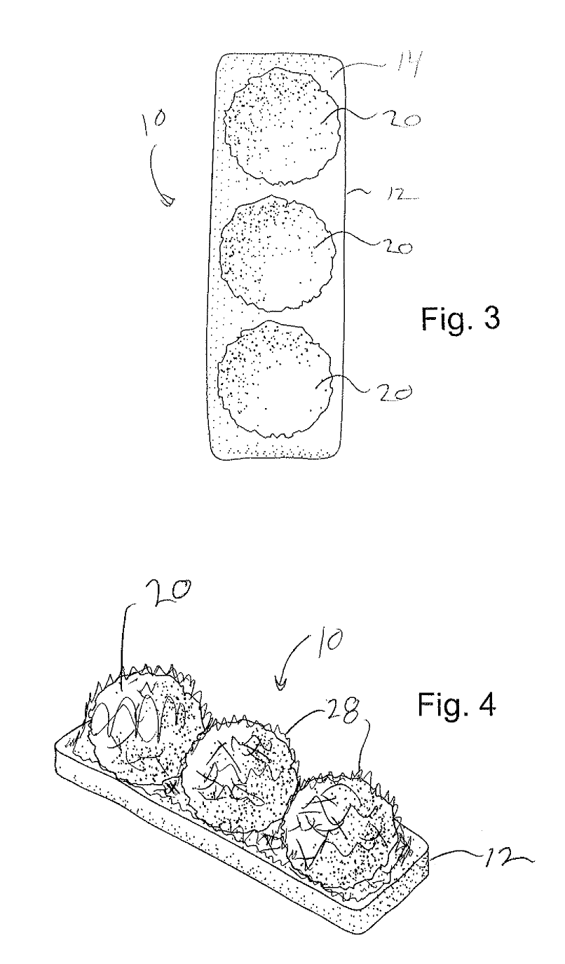

Turning to FIGS. 1-3, a first embodiment of the present invention relates to an insert or filling 10 for a meatball sandwich. The insert comprises a substantially flat base 12 having flat upper and lower faces 14 and 16, respectively. The base consists of a thin sheet. An array of generally spherical meatball-like projections 20 extend upwardly from the upper surface 14. Although the projections 20 may have the appearance of individual meatballs, especially when the insert is situated within a bun, the projections are in fact joined together through the base 12, such that the base and projections comprise a one-piece structure. The projections 20 preferably have a roughly spherical shape, as is conventional for meatballs. However, it will be seen that projections 20 may be provided in any convenient and suitable configuration, whether cube-like, ovalized sphere, or other non-spherical shape. The projections may comprise a hemisphere, or any other portion of a sphere. The projections may comprise any combination of such shapes. However, a preferred configuration is for the projections 20 to have a shape which is substantially spherical or a somewhat flattened sphere similar to a conventional meatball. The projections 20 may be positioned on the base to be in contact with each other, as seen in FIG. 3, or spaced apart. While a close spacing of the projections can be desirable in a sandwich, spacing the projections apart assists to promote more uniform cooking, freezing, re-heating prior to serving, and application of sauce. As well, spaced apart projections can be more efficient in that they utilise less meat substrate; this is desirable to compensate for the meat required to form the base 12.

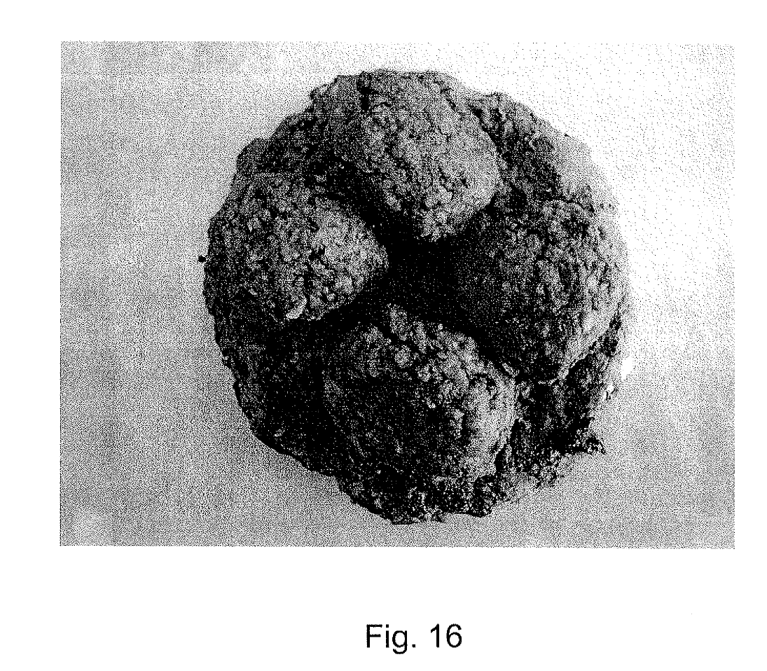

As seen in FIG. 4, the filling 10 may be coated with sauce, such as a conventional tomato-based sauce, prior to the freezing and packaging steps. The coated product is then ready to serve to a customer. As well, the filling 10 may be coated with additional foodstuffs such as grated cheese, as seen in FIG. 16.

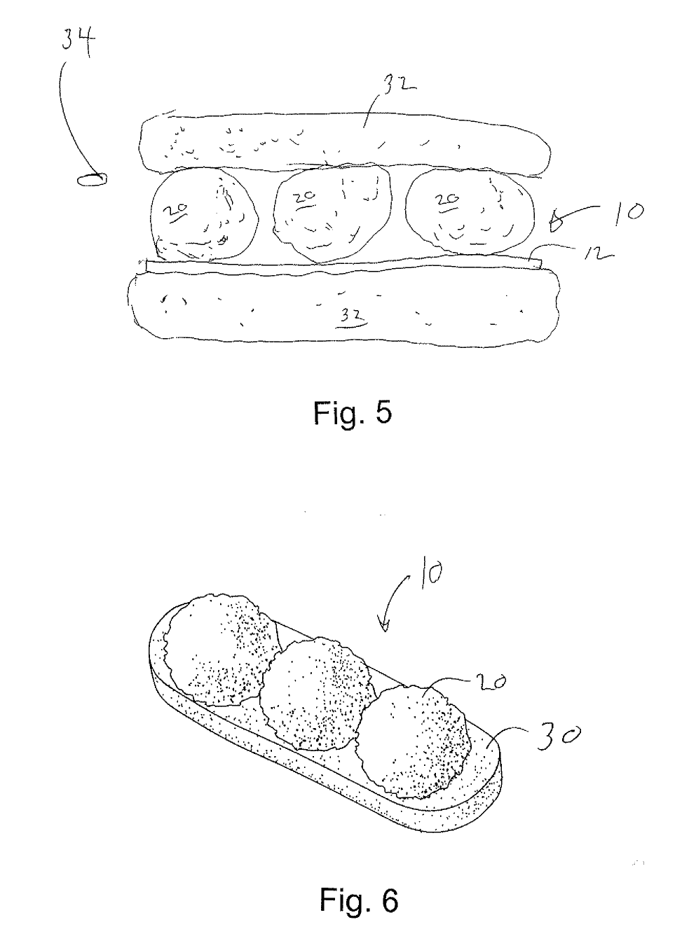

The configuration of the base 12 can vary widely, depending on the desired type and configuration of sandwich. In the embodiment illustrated in FIGS. 1-3, the base comprises an elongated rectangular shape, which is particularly suited for a meatball submarine sandwich or other, similar, elongate-type sandwich. However, as seen in FIGS. 5-11, and as will be readily apparent, other configurations may be provided. Examples of such alternative configurations include a generally circular base for use in a round bun, or a square base for a square sandwich, and so forth. The only practical limit to such configurations is dictated by consumer or market forces, as well as practical limits to the size of the insert 10. The thickness of the base 12 is likewise variable, and dictated by several considerations. For example, a thicker base provides increased support, resistance to tearing or breakage, and other benefits. However, a thicker base also requires an increased meat content, which may not always be desirable. According to one aspect, presented only as a working example, the base has dimensions of about 6.0 inches long, 1.4 inches wide and 0.6 inches thick. The base weight (uncooked) is about 2.0 oz. The corners of the base may be squared or rounded, or the base may be boat-shaped, tapered, or take on any other desired and suitable configuration, depending on the preferred use. In general, it is preferred for the base to take on a configuration substantially similar to the configuration of the breadstuff that will be used for the sandwich.

In the above example, the meatballs 20 may each have a diameter of approximately 1.2 inches and an uncooked weight of about 0.5 oz.

In other configurations as described herein, the base may comprise between 1-2 oz and the meatballs can vary in size, to provide a total weight of the insert of about 3-5 oz. It is stressed that these values are presented merely by way of example, and a wide range of sizes and configurations is contemplated.

The region where the projection 20 joins the base 12 forms a contact region 22 (seen in FIG. 2). Normally, if the projection 20 is generally spherical, the contact region 22 is substantially circular. As is evident, the shape of this region will be dictated by the configuration of the projection 20. The size of the region 22 is largely dictated by practical and functional considerations. A larger region results in a more robust product, in which the projections are more resistant to inadvertent separation from the base. It will be seen that a sufficiently large contact region 22 results in the projection 20 having a hemispherical or near-hemispherical shape. However, there are also factors which favour a smaller contact region. In the embodiments wherein the filling is coated with sauce prior to freezing, it can be also desirable to provide a somewhat reduced size of the region 22 in order to somewhat increase the area of product which is coated by sauce, in that the contact region is uncoated. As well, a larger region 22 represents a departure from the spherical shape of the projection 20, and for this reason the size of the region 22 should be optimized as a balance between the above competing considerations, as well as additional considerations.

The substrate possesses properties of moldability and the ability to retain its shape post-molding prior to cooking. As well, following cooking the substrate permits the molded foodstuff to remain robust so as to retain its shape and remain intact when subjected to normal movement and stress that a commercial product of this nature is subjected to. In particular, the base portion is sufficiently robust prior to and after cooking to minimise breakage or deformation, and to prevent the projections 20 from separating from the base.

A preferred substrate consists of the following mixture:

| | |
|---|---|
| ground meat | approx. 65-100% |
| binders and extender | approx. 0-12% (about 6.8% if using soya |
| | protein isolate) |
| seasoning | about 0%-3% |
| water | about 0%-20% |

In the above substrate, the ground meat may comprise any combination of beef, pork, poultry, fish, soya or vegetables. The binders and extenders may comprise cereals, bread crumbs, cracker meal, soy flour, soy protein concentrate, isolated soya protein, textured soya protein, rice or pulled bread. The seasoning may comprise any suitable blend of seasoning or single seasoning.

An alternative substrate consists of a ground meat mixture which when cooked has a taste and texture substantially emulating prime rib from a single cut or source piece. Such a substrate is described in Canadian Patent No. 2,444,785 and according to one broad aspect comprises: lean beef prime rib meat in the amount of about 30%-75% by weight, said lean meat comprising a fat content of about 3-20% by weight; fat beef prime rib meat, in the range of about 20%-45% by weight, said fat meat comprising a fat content of about 65%-95% by weight; seasoning in the range of 0%-4% by weight; and optionally added water in the range of 0%-20% by weight of the mixture; wherein said lean and fat meat comprises meat from different sources and said mixture is ground to a texture suitable for use in a prepared meat product.

It will be seen that the above examples represent merely preferred substrates, and any suitable edible substrate may be used that can be formed in the foodstuff described herein that meets the needs of the consumer. For example, a vegetarian substrate may be used, or a poultry or seafood-based substrate. It is also contemplated that the base and projections 20 may be formed from two different substrates. In this version, the base and projections 20 may be separately formed, followed by attaching the projections 20 onto the base 12, for example by forcing them together or fastening the projections onto the base by use of an edible cement or cement-like substance. Likewise, even if the base and projections comprise the same substrate, they may be formed separately and subsequently joined together so as to form a one-piece structure.

According to another aspect, a method of preparing an insert according to the invention is provided, as well as methods of packaging, re-heating and serving the insert. The method comprises the following steps:

1. A selected quantity of the primary substrate ingredient is provided. This may comprise any suitable meat or non-meat foodstuff or mixture thereof. The meat may comprise any suitable cut of beef, pork, poultry, fish or other meat. Potential non-meat foodstuffs include vegetables, soy, etc. The selected quantity of substrate is ground or chopped to a degree suitable for use as a meatball. Preferably, the substrate is ground to a degree such that individual chunks cannot be detected by the consumer.

2. Additional ingredients are combined with and mixed into the mixture in a selected quantity, such as seasoning, salt, binders, fillers, preservatives, antioxidants, water, or other ingredients, to form a moldable substrate.

3. The substrate is fed into a molding or forming apparatus, which includes forming plates to form the individual sandwich fillings described herein. The molded fillings are then removed from the mold for further processing.

4. The formed uncooked fillings are deposited on the belt of a moving belt cooker for cooking within an oven or other cooking apparatus.

5. The cooked product is fed into a moving belt chilling tunnel for chilling.

6. Optionally, a layer of sauce is applied using water fall type of sauce applicator such that the sauce coverage is limited to the meat ball units and only the top surface (or portion thereof) of the base. The application of sauce in this fashion avoids the application of sauce to completely surround the product (as is often done with conventional individually formed meatballs) which can allow sauce to drip from the coated product. This prevents the sauce from dripping into the equipment and clogging the freezer belt and other equipment during processing, thereby permitting freezing of the sauced product using generally conventional freezing and processing equipment. Other substances may be optionally applied to the filling, such as grated cheese or the like.

7. The cooked fillings, optionally coated with sauce and/or other coating layers, are conveyed to a moving belt freezer to be frozen and packaged for delivery, either individually or in bulk.

It will be seen that parameters of the process for preparing the product, such as cooking and freezing times and temperatures, may vary depending on chosen meat ball substrate, desired thickness of base, size of meat balls, and the presence, type and quantity of sauce.

The method of production described herein permits the manufacture of the sandwich filling as a pre-sauced product, using a linear manufacturing line to carry out the steps of cooking, chilling, applying sauce and freezing.

At the consumer end, the filling 10 is re-heated to a temperature suitable for serving, for example within a microwave oven. The re-heating step may be performed within the packaging, provided the packaging permits such re-heating, or alternatively removed from the packaging prior to re-heating. The heated fillings are then placed within a suitable roll or other sandwich casing 32, for serving to the ultimate consumer. If the filling has been supplied without a sauce coating, sauce may be added to the sandwich prior to delivery to the consumer.

A submarine-type sandwich 34 which includes the filling 10 is shown in FIG. 5. It will be understood that this is but a one example of many possible forms and configurations of sandwiches that may be provided with the present invention.

While it is contemplated that the filling 10 is pre-cooked and frozen at the manufacturing facility, for subsequent re-heating and serving, it alternatives are also contemplated. For example, the filling 10 may be frozen and packaged in an uncooked state, such that full cooking is required immediately prior to serving. As well, the filling 10 may be supplied in an unfrozen, refrigerated state in either an uncooked (fresh) or cooked form, such that the product need not be thawed during the reheating step. It is also contemplated that the filling 10 may be formed “on site” in a serving establishment. In this process, a suitable substrate is molded on-site, for example in a food serving establishment, either immediately prior to cooking and serving, or in advance.

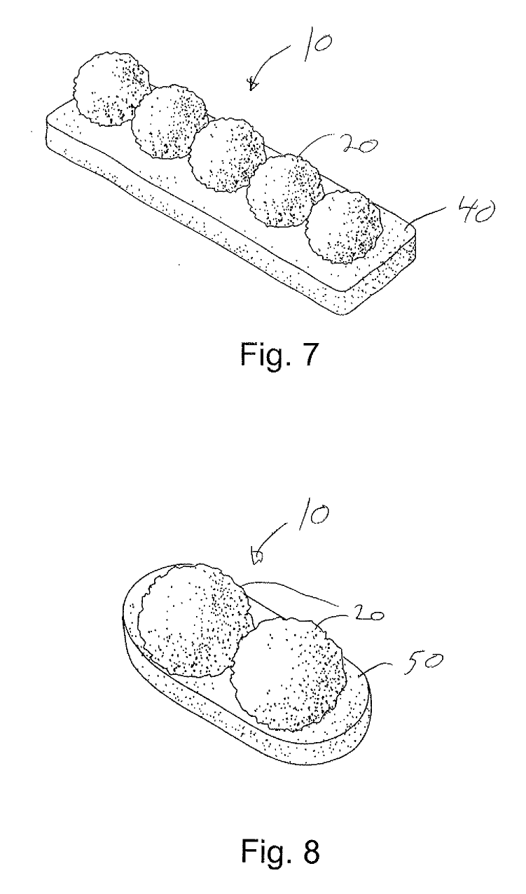

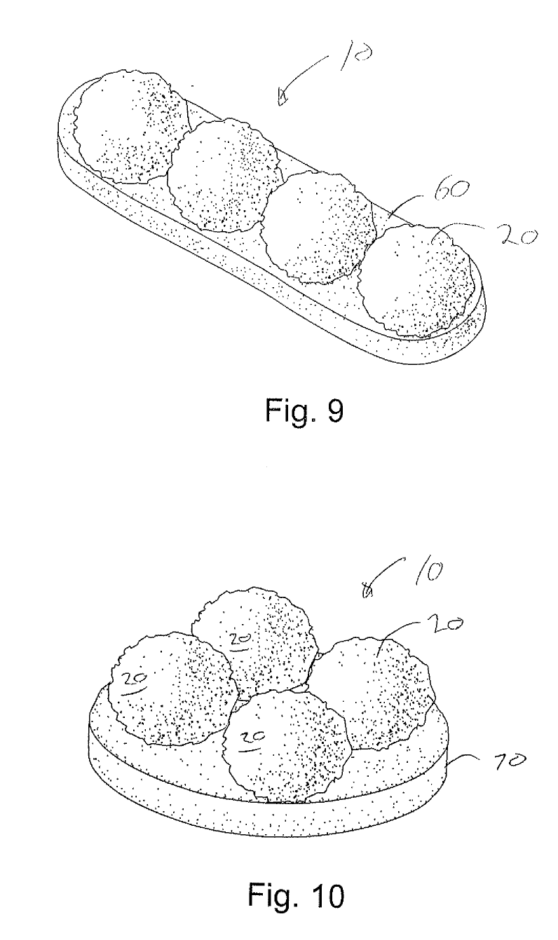

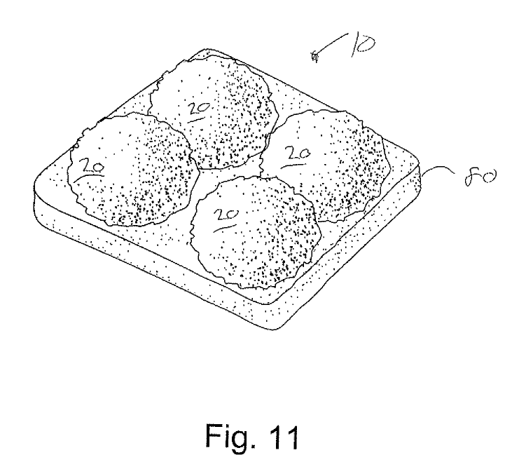

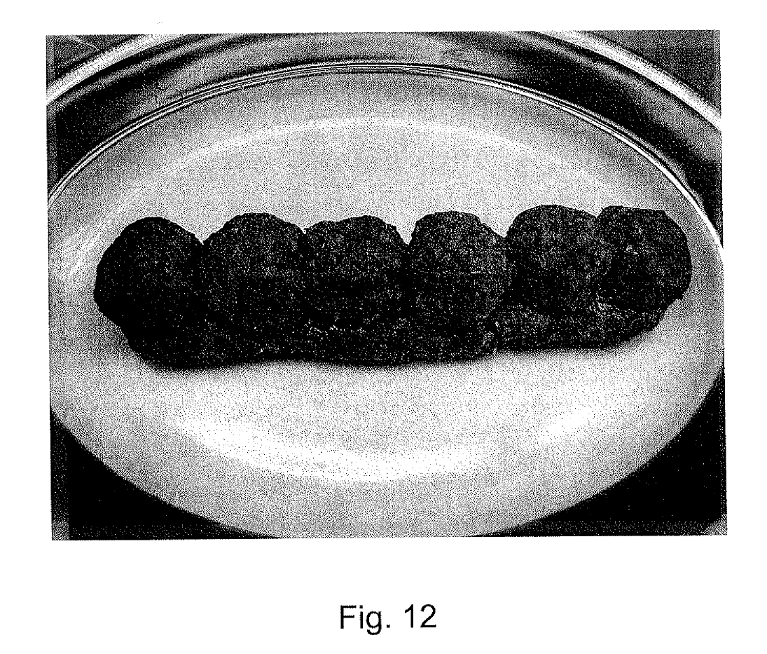

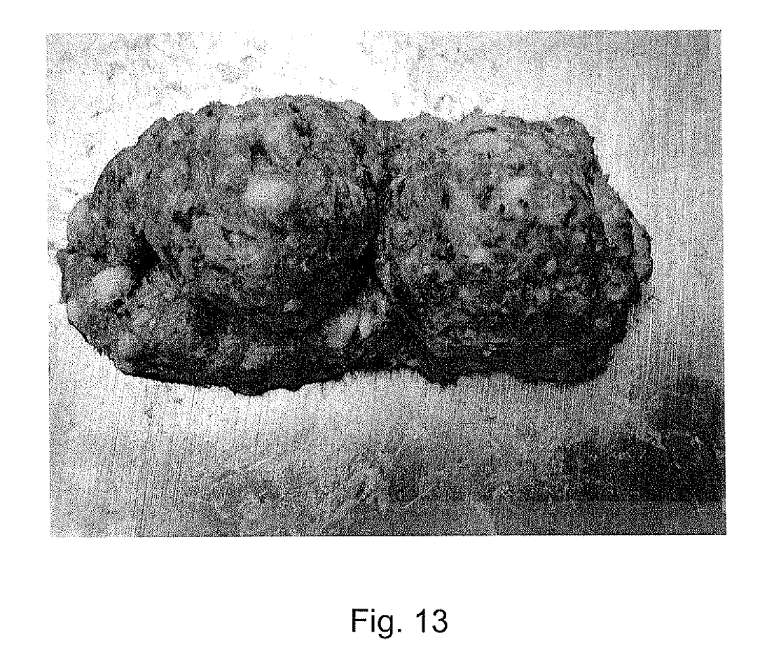

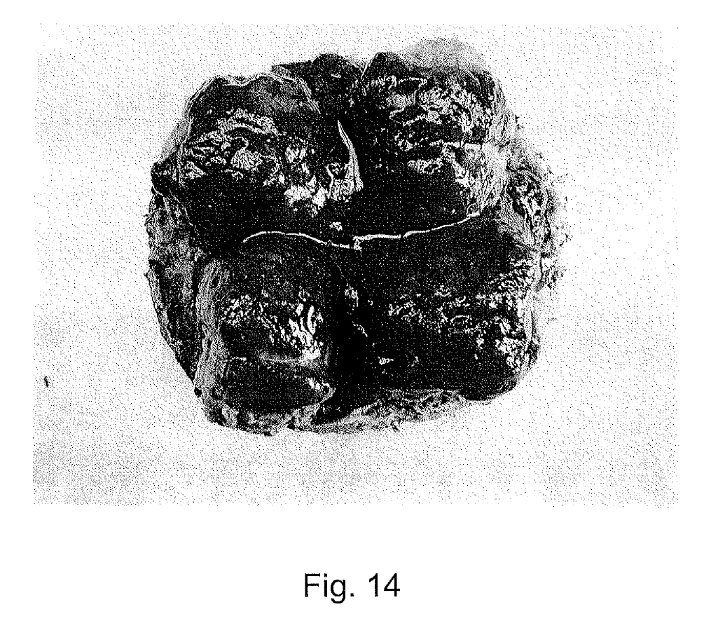

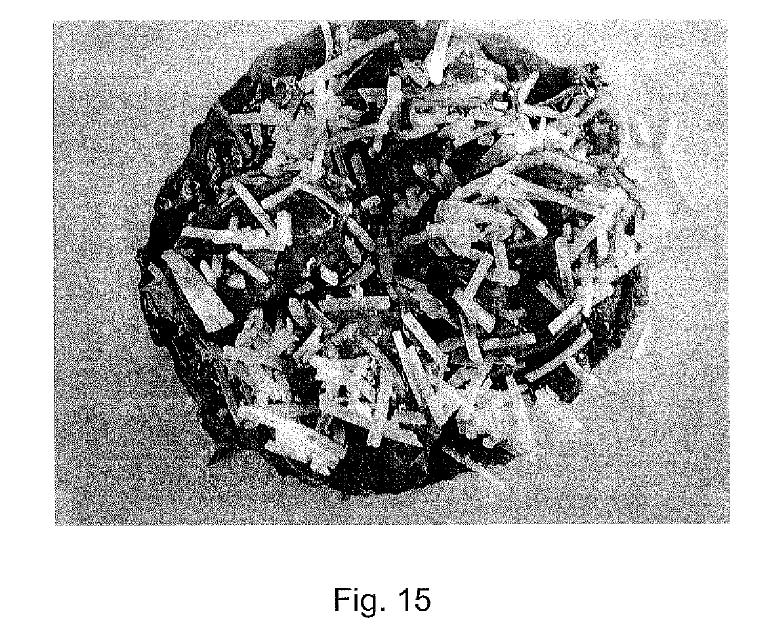

Several alternative embodiments of a filling according to the invention are shown in FIGS. 6 through 16, which show various alternative embodiments. FIG. 6 relates to a filling 10 with an oval base 30 and three meatball-like projections 20. FIG. 7 relates to a filling 10 with an elongate rectangular base 40, with an array of about five meatball-like projections 42 that are smaller in diameter relative to the previous embodiments. FIG. 8 relates to a filling with a base 50 having a similar base as in FIG. 6, but shorter in length to accommodate only two projections 20. FIG. 13 is a photograph of this embodiment in an uncooked state. FIG. 9 relates to an insert 10 with a base 60 having a similar base as in FIG. 6, but longer in length to accommodate four projections 20. FIG. 12 is a photograph of a similar embodiment with 6 meatballs. FIG. 10 relates to a filling 10 having a circular base 70 which accommodates about 4 projections 20. FIG. 14 is a similar embodiment coated in sauce and FIG. 15 is a similar embodiment with an additional layer of cheese. FIG. 16 shows a similar embodiment in an uncooked state. FIG. 11 relates to a filling 10 having a generally square base which accommodates about four projections 20.

The present invention has been described above by way of a detailed description of certain embodiments thereof. However, it will be seen that this description has merely described embodiments of the invention. The full scope of the invention is not limited to the specific embodiments described herein. Rather, the invention is fully described in the present patent specification taken as whole, including the claims, as understood by the person of ordinary skill in the art. The invention includes departures from and variations of the embodiments described herein. It will be further understood that the invention includes equivalents of elements identified, described, or eluded to herein. While every reasonable effort has been made to fully and explicitly describe the entire scope of this invention, it will be understood that persons skilled in the art may recognize functional or mechanical equivalents to elements described herein which may not be explicitly described herein. It is contemplated that all such equivalents are included within the scope of this invention.

1. A one-piece edible filling for a meatball sandwich, comprising a generally flat base with an array of projections protruding from said base, each of said projections generally having the configuration of a meatball or portion thereof, wherein said filling is configured to form a filling for bun, roll or other sandwich casing to form a meatball sandwich when combined with said sandwich casing.

2. A filling as defined in claim 1 wherein said base has the configuration of:
an elongate rectangle
a square
an oval
a circle or
an ellipse.

3. A filling as defined in claim 1 wherein said filling is pre-cooked and frozen.

4. A filling as defined in claim 3 wherein at least a portion of the upper surface of said filling is coated with a sauce.

5. A filling as defined in claim 1 wherein said foodstuff comprises ground meat or a vegetarian foodstuff.

6. A filling as defined in claim 5 wherein said ground meat comprises lean beef prime rib meat in the mount of about 30%-75% by weight, said lean meat comprising a fat content of about 3-20% by weight; fat beef prime rib meat, in the range of 20%-45% by weight, said fat meat comprising a fat content of about 65%-95% by weight; seasoning in the range of 0%-4% by weight; and optionally added water in the range of 0%-20% by weight of the mixture; wherein said lean and fat meat comprises meat from different sources and said mixture is ground to a texture suitable for use in a prepared meat product.

7. A filling as defined in claim 1 wherein said filling is molded from a moldable substrate.

8. A filling as defined in claim 1 wherein said base comprises a thin sheet.

9. A filling as defined in claim 1 wherein all said projections extend solely from a single face of said base.

10. A filling as defined in claim 1 in combination with a sandwich casing.

11. A method of forming a one-piece edible filling for a meatball sandwich, comprising the steps of:
forming a one-piece sandwich filling entirely from an edible foodstuff, said filling comprising a generally flat base with an array of projections extending from said base, each of said projections having the general configuration of a meatball;
cooking said one-piece filling; and
supplying said cooked one-piece filling for insertion within a roll or breadstuff to form a meatball sandwich.

12. A method as defined in claim 11 comprising the further steps of freezing said one-piece filling subsequent to cooking, and packaging said frozen filling, for subsequent heating and use within a sandwich.

13. A method as defined in claim 12 comprising the further step of coating at least a portion of an upper surface of said filling with sauce prior to freezing.

14. A method as defined in claim 13 wherein said projections protrude from an upper face of said base and said sauce covers only said projections and the upper surface of said base or a portion of said upper surface.

15. A method as defined in claim 11 wherein said filling comprises the filling defined in claim 1.

16. A method of preparing a one-piece edible sandwich filling comprising the steps of:
a) providing a selected quantity of a primary ingredient comprising meat or non-meat foodstuff or mixture thereof in ground or chopped form,
b) optionally combining into said primary ingredient a selected quantity of additional ingredients selected from one or more of seasoning, salt, binders, preservatives, antioxidants or water to form a moldable substrate,
c) molding said substrate into a one-piece edible filling for a meatball sandwich, comprising a generally flat base with an array of projections protruding from said base, each of said projections generally having the configuration of a meatball or portion thereof, wherein said filling is configured to form a filling for bun, roll or other sandwich casing to form a meatball sandwich when combined with said sandwich casing,
d) depositing said filling on the belt of a moving belt cooker and cooking said filling,
e) chilling said cooked filling in a moving belt chiller,
f) optionally, applying a layer of sauce to said filling such that the sauce covers at least a portion of the upper surface of said filling,
g) conveying said filling to a moving belt freezer and freezing said filling therein, and
h) packaging said frozen fillings.

17. A method as defined in claim 16 wherein said steps of cooking, chilling, optional application of sauce, and freezing are carried out in a linear manufacturing line.
